(19) United States
(12) Patent Application Publication
(10) Pub. No.: US 2015/0096220 A1
(43) Pub. Date: Apr. 9, 2015

(54) Fishing lure

(71) Applicant: Larry W. Buhler, Claremore, OK (US)

(72) Inventor: Larry W. Buhler, Claremore, OK (US)

(21) Appl. No.: 13/998,166

(22) Filed: Oct. 8, 2013

(51) Int. Cl. A01K 85/14

(52) U.S. Cl. CPC A01K 85/14
USPC 43/42.11

(57) ABSTRACT

This fishing lure exemplifies a device which is intended to attract game fish and cause their curiosity to become overwhelming by providing smooth, easy, movement thru the water, rather than a random, erratic movement, which always upsets the preferred game fish and reduces the results. The lure comprises a non-flexible wire formed in a Vee-shaped fashion connected to a fishing line by a central loop component with a rigid body member of light plastic in swivel attachment to a first arm of the Vee and a spoon connected to a second arm of the Vee in rotatable condition, whereby the body and spoon provide a rhythmical movement thru the water as may be chosen by the sportsman.

### BACKGROUND OF THE INVENTION

The history of fishing with spinner bait has clearly been based on the concept of relying on the combination of an artificial lure and spinner blade and fish hook in a V-shaped design of a wire arrangement which will be the most attractive arrangement to indicate the appearance of the most beneficial meal and avoid appearing as the slightest threat of a dangerous carnivorous sea monster. It has always seemed logical that the most araction is accomplished by providing a fishing lure that gives the appearance of a calmly traveling and innocent meal.

The lure is made to simulate an injured small fish so that the movement of the lure thru the water can be shown as normal movement of a fish.

The speed of retrieval should be made to closely resemble the normal action of the chosen fish. It is never successful to give the lure an unnatural movement of any kind. Then, when a jig is added to the line, the hook should be most efficiently covered from the sight of the fish.

I have not placed any heavy weight on the line or within the body because I want to be able to return the lure along a path only below the surface of the water and to give the lure a more natural movement during retrieval.

### SUMMARY OF THE INVENTION

For my fishing lure I have arranged my chosen components in a manner to provide a rhythmical movement thru the water which is most natural, by means of smooth, calculable orientation instead of any random movement which is usually produced by an unbalanced structure, and, especially, by one component having a much more diverse surface than other smaller components of the lure positioned thereby, as perhaps a large spoon with a concave side at an unbalanced position on the lure.

I prefer to attach the active fishing tackle to the end of the fishing line by use of an almost non-flexible wire, usually described as 0.041 inch wire; always with a lure, a spinner, and hook component placed far enough apart from each other to provide a neat, rhythmic, reasonable pattern as the lure is being retrieved to avoid any type of disruptive movement that would otherwise appear dangerous to the fish.

Any unfamiliar action is suddenly recognized by the intended game fish and would seem to portray an attacking member, and it would appear that the attacker, by the diametric extent of movement of the water depicts a violent animal that is many times the size of the game fish. For example, a diametric disturbance in the water of 12 inches might indicate a gar fish six feet long, or some other violent animal many times the size of the game fish.

### OBJECTS OF THE INVENTION

I have chosen the various components to resemble bait movements known and recognizable to the fish, and to imitate that appearance and behavior in order t o deceive the fish, but never to make the lure too outlandish to cause complete distraction.

The body member is comprised of light plastic such as an expanded polystyrene call Styrofoam in order that when the body member is molded the wires that are shown integrated with the body member are held in place for proper connection with the body member.

I prefer to have the components formed of a weight that is easily pulled slightly below the surface of the water.

All the wires are practically non-flexible, e.g. only very slightly flexible, so that they will give a most natural movement of the lure thru the water.

In the figures I describe the lengths of the various connections I prefer. In operation, the wire bearing the fish hooks may vary from a single wire to as many as five wires, and the length I prefer is from five to six inches.

I prefer the wires for the hooks to be angularly dispersed almost as the drawings indicate, either as shown in a flat plane, or even to be shown in an arc arrangement.

The spinner is to give a means of movement or action to the fishing lure that will most successfully generate attraction to the fish by the rotational movement of one component while an actual portion of real bait is nearby on a hook.

### BRIEF DESCRIPTION OF THE DRAWINGS

FIG. 1 is a perspective view of a present embodiment of my fishing lure in an enhanced arrangement of components.

FIG. 2 is a perspective view of a fishing lure according to my invention as it might be equipped with fewer components under certain circumstances.

FIG. 3 is a perspective view according to my invention as the choice of components might be adjusted depending upon various circumstances.

FIG. 4 is a partial perspective view of a perspective view according to my invention to indicate a method of securing wire components within a plastic component for utmost security

### DESCRIPTION OF THE PRIOR ART

The prior art that I considered to be the pertinent to my invention consisted of the following material:

| | | |
|---|---|---|
| Reynolds | U.S. Pat. No. 1,320,570 | Nov. 4, 1919 |
| Hudson | U.S. Pat. No. 3,500,573 | Mar. 17, 1970 |
| Stout | U.S. Pat. No. 4,536,986 | Aug. 27, 1985 |
| Stanczyk | U.S. Pat. No. 4,671,007 | Jun. 9, 1987 |
| Dubois | U.S. Pat. No. 6,018,901 | Feb. 1, 2000 |
| Loniello | U.S. Pat. No. 6,158,162 | Dec. 12, 2000 |
| Hammond | U.S. Pat. No. 6,665,977 | Dec. 23, 2003 |
| Moore | U.S. Pat. No. 6,701,662 | Mar. 9, 2004 |
| Mathews, Jr. et al. | U.S. Pat. No. 6,796,080 | Sep. 28, 2004 |
| Selvaggio | U.S. Pat. No. 7,437,849 | Oct. 21, 2008 |

Reynolds, 1,320,570, shows a Vee-shaped wire having a body and hook component attached to each en d of the wire.

Hudson, 3,500,573, shows a Vee-shaped wire having a central loop for attachment to a fishing line with a weighted hook attached to a first end and a spinner attached to a second end. Stout, 4,536,986, shows a Vee-shaped wire attached to a fishing line having two spinner blades at a first end, a body and hook at second end with an elongated skirt member positioned between the body and the hook.

Stanczyk, 4,671,007, shows a wire member formed as a Vee being attachable to a fishing line thru a central loop having a spinner attached to a swivel at the central loop, and decorated hook members attached to each of the ends of the Vee-shaped wire.

DuBois, 6,018,901, describes a wire member formed in a Vee, having a central loop connection to a swivel at the end of a fishing line, with an elongated tube extending from a first end of the wire and a lure body and hook at the second arm being spaced apart from the first.

Loniello, 6,158,162, shows a lure comprising a wire shaped in a Vee manner with the central portion forming an eye to which the fishing line is attached, and with a sliding blade on a first arm and a trailing blade secured to the end, and with a body plus and hook members secured on a second arm member.

Hammond, 6,665,977, shows a lure of flexible tubing having a chain extending thru the tubing in an arced manner, a blade attached to a first end, a hook attached to a second end, and a filamentary skirt surrounding the hook.

Moore, 6,701,662, describes a lure as a double wire device with a spinner wire and a hook member attached to an immovable triangular wire member which is attached so that the wire components retain a fixed position.

Mathews, 6,796,080, shows a lure that includes a pair of arms connected in a Vee manner in which a first arm is a wire and a second arm is plastic. A spinner blade is mounted to the first arm and a decorated hook component is attached to the second arm.

Selvaggio, 7,437,849, describes an attractant element that includes a wire element with a loop at each end made to move slid ably along the fishing line.

### DESCRIPTION OF A PREFERRED EMBODIMENT OF THE INVENTION

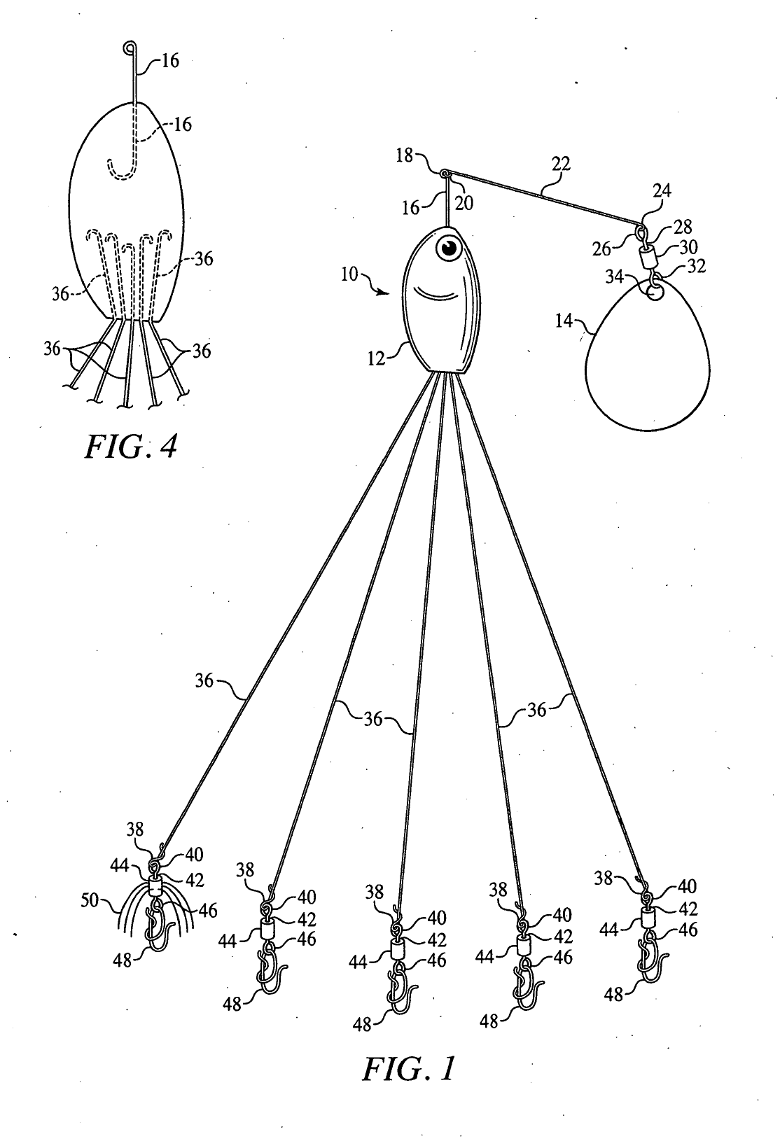

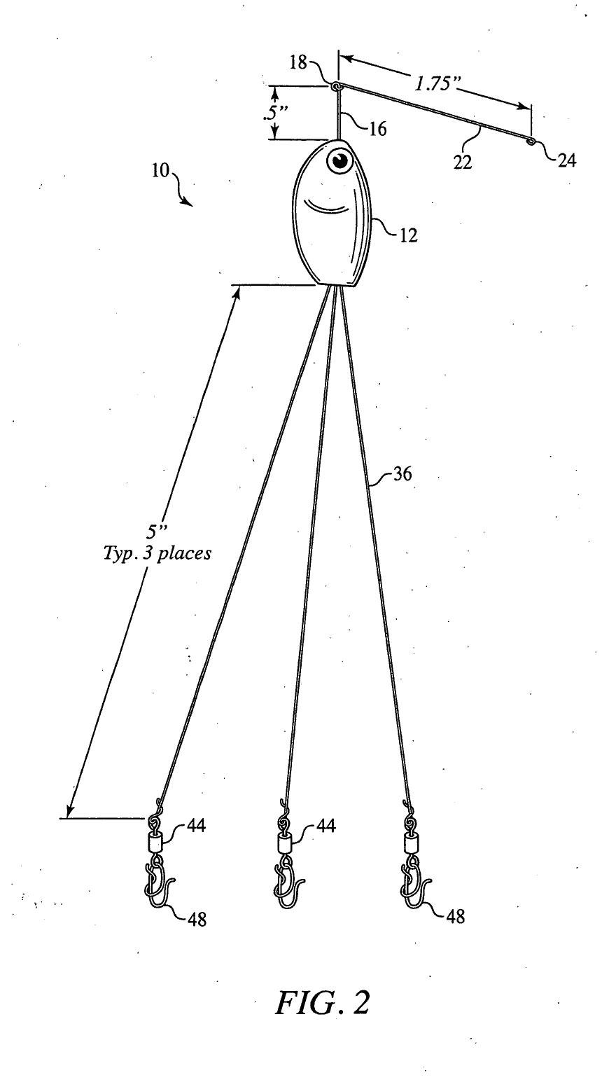

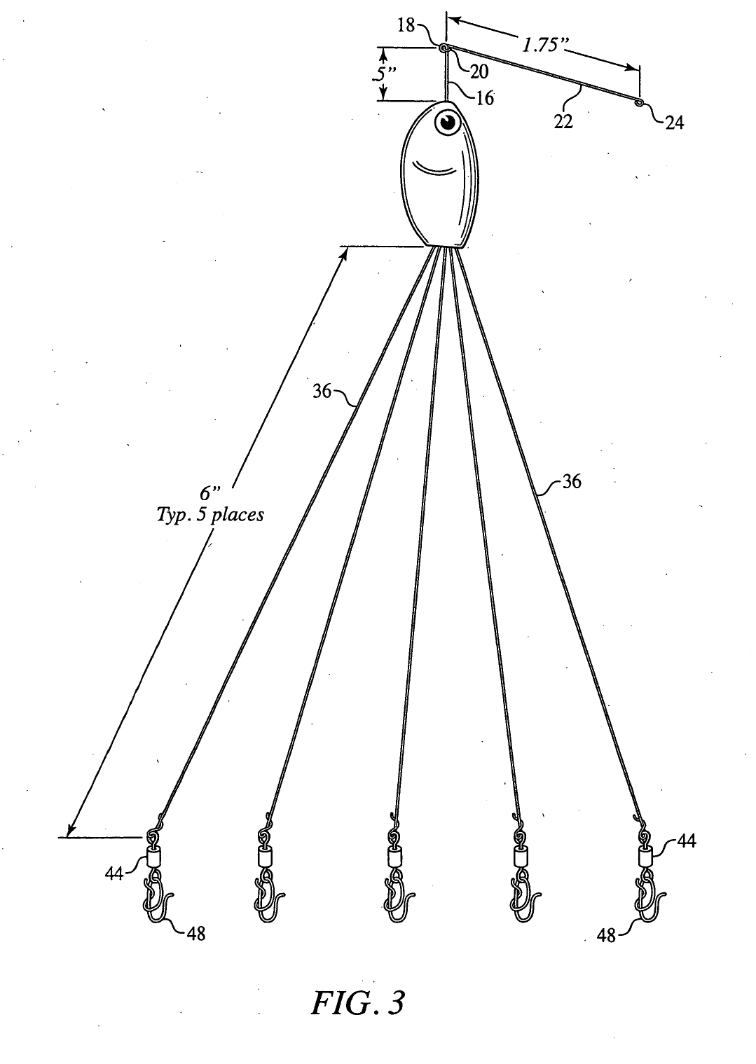

I have shown in the drawings the purposes I have achieved by the construction of my fishing lure as I anticipated. In FIG. 1 I show my fishing lure 10, generally, comprising a fishing lure body member 12 in connection with a spinner blade 14 which are connected by a wire member 16 extending from one end of body member 12 by means of an eye loop 18 in loose connection with eye loop 20 at a first end of wire member 22 extending suitably to an eye loop 24 at a second in loose connection with another eye loop 26 at an end of a short wire 28 which extends in swivel connection thru swivel member 30 having an eye loop 32 in loose connection thru an eye 34 near an end of spinner blade 14. Spinner blade 14 is only very slightly formed with a concave formation in order to achieve the most controllable I prefer.

I show in FIGS. 1 and 4, as I explained above, the manner in which I have made the ends of lines 16 and 36 to be molded integrally in the body member 12 to secure a firm stability for the most active component of the fishing lure.

The fisherman may use a lure supplied with a varied number of lines 36 which should correspond favorably to certain conditions he is encountering at that particular time, and as depending upon the physical and natural climate phases of the area, the type of fish he expects to catch, and his own experiences. As I described, the length and angular orientation of these lines should provide the most favorable movement of the lure thru the water.

At the extended end of wire members 36 I have provided an eye loop 38 which is in loose connection with an eye loop 40 at an end of a short wire 42 which extends thru swivel member 44 to provide the limited amount of swivel I prefer for those extended members. At the extended end of wire 42 I placed an eye loop 46 which provides loose connection to the particular type of easy access connection 48 for my fish hooks. Then, as a fisherman prefers, I show a small supply of feathery hook-concealing members 50 in connection with swivel member 44, as in common practice today. Again, the number may depend upon all conditions.

I claim:

1. A fishing lure comprising:
A rigid body member of light weight plastic and a spoon member, both members attachable near an end of a fishing line and held by attachment means, whereby
Said attachment means includes initial loop means for holding body member and spoon in cooperative connection, and
Said attachment means comprises a first non-flexible wire extending from an integral position within said body member to a loop thereon into cooperation with said initial loop means, and
Said attachment means comprises a second non-flexible wire extending from a loop thereon to a swivel in connection with said spoon member to provide rotatable attachment for said spoon member to said fishing line, and
Said attachment means further comprises a non-flexible wire extending from an integral position within said body member to a hook means held in a rotatable position from said body member to provide rotatable attachment to said hook means.

2. A fishing lure as described in claim 1, wherein said spoon member is slightly concave.

3. A fishing lure as described in claim 1 wherein said lure comprises:
A multiplicity of hook units which are all attachable to the body member by individual wire members of the same length.

4. A fishing lure as described in claim 3, wherein said individual attachable to said hook units each extends from a first end in connection within said body member for a chosen length to a loop position at a second end thereof.

5. A fishing lure as described in claim 4 wherein each of said hook units comprises rotatable connection means to said body member.

6. A fishing lure as described in claim 1 wherein said hook unit comprises:
A multiplicity of flexible colored strip members providing concealment means for a hook from the vision of a fish and of light weight and sufficient flexibility to assure an easy grasp by an attracted fish.

7. A fishing lure as described in claim 1 wherein said attachment means includes a releasable fastener holding said body member and said spoon member in cooperative connection.

8. A fishing lure as described in claim 1 wherein said attachment means comprises:
A V-shaped wire member of a selected length having releasable attachment means for connection of said body member and said spoon member.

9. A fishing lure comprising:
A rigid body member of light weight plastic and a spoon member, both members attachable near an end of a fishing line and held by attachment means comprising:
A first non-flexible wire extending from an integral position within said body member to a loop at an external end of said wire, and
A second non-flexible wire extending from a loop member in cooperation with said initial loop to a swivel in connection with said spoon member to provide rotatable attachment for said spoon member to said fishing line, and
Said attachment means further comprises a non-flexible wire extending from an integral position within said body member adjacent a second end of said body member to a hook unit held in a rotatable condition from said body member.

10. A fishing lure as described in claim 9, wherein said spoon member is slightly conceve.

11. A fishing lure as described in claim 9 wherein said lure comprises:
A multiplicity of hook units, attachable by wire members of same length.

12. A fishing lure as described in claim wherein said individual wire members each extends from a first end in connection within said body member for a chosen length to a loop member in position at a second end thereof.

13. A fishing lure as described in claim 12 wherein each of said wire members comprising said hook units comprises rotatable connection means involving attachment thereto of said hook unit.

14. A fishing lure as described in claim 9 wherein said hook unit comprises:
A multiplicity of flexible colored strip members to provide concealment of a hook form the vision of a fish and is of light weight and flexible enough to assure an easy grasp by an attracted fish.

15. A fishing lure as described in claim 9 wherein said attachment means includes a releasable fastened holding said body member and said spoon member in cooperative connection.

16. A fishing lure as described in claim 9 wherein said attachment means comprises:
A V-shaped wire member of a selected length having releasable attachment means for connection of said body member and said spoon member.
